(19) United States
(12) Patent Application Publication
(10) Pub. No.: US 2002/0077961 A1
(43) Pub. Date: Jun. 20, 2002

(54) Performer income trading system and method

(76) Inventors: Daniel J. Eckert, Chicago, IL (US); Ross J. Eckert, Lewiston, NY (US); Todd O. Perry, Lakewood, OH (US); Christopher W. Claus, North Royalton, OH (US)

Correspondence Address: Harold C. Moore, Maginot, Addison & Moore, Bank One Center/Tower, 111 Monument Circle, Suite 3000, Indianapolis, IN, 46204-5115, US

(21) Appl. No.: 09/933,262

(22) Filed: Aug. 20, 2001

Related U.S. Application Data
(60) Provisional application No. 60/226,419, filed on Aug. 18, 2000.
(60) Provisional application No. 60/298,546, filed on Jun. 14, 2001.

(51) Int. Cl. G06F 17/60

(52) U.S. Cl. 705/37

(57) ABSTRACT

A system for trading in a security having a value based on the prospective income of a performer includes a first processor and a plurality of remote processors. The first processor receives and stores a plurality of bids for the purchase of one or more security instruments, each security instrument having a value based on the prospective income of a performer, the value based at least in part on a contingent portion of the prospective income, the prospective income being service based. The plurality of remote processors are further adapted operable to communicate the plurality of bids to the first processor.

This application claims the benefit of U.S. Provisional Patent Application Serial No. 60/226,419, filed Aug. 18, 2000, and U.S. Provisional Patent Application Serial No. 60/298,546, filed Jun. 14, 2001, both of which are incorporated herein by reference.

### FIELD OF THE INVENTION

The present invention relates generally to securities trading, and in particular, to forming a market and tradable security for trading an interest based on the income of a performer.

### BACKGROUND OF THE INVENTION

Various tradable investment options exist for the individual and the institutional investor. Such options include equities in the form of stock that provide ownership of corporations, debt instruments in the form of bonds that lend money to corporations or governmental entities, as well as combinations of investments in the form of shares of mutual funds and the like.

Investments are typically made with the desire to increase wealth. The return on any investment is often unpredictable. While the unpredictability of return may be reduced by electing conservative investment strategies, some element of chance typically remains.

However, many people derive enjoyment and excitement, at least to some extent, from the unpredictable nature of investment markets, and see some level of investing as entertainment. Investing to some degree is akin to wagering. One “wagers” that one's stock value or bond value will rise. Unlike pure gambling, however, investment markets can grow over time, and are not mathematically contrived for “players” to lose.

Some of the entertainment value in investment markets arises from the opportunity for the investor to invest based on knowledge, belief and trends. At least theoretically, investors select investments that they (or their advisers) believe have a good chance of providing a decent return. In this manner, the “winning” investor believes that he or she is a savvy investor.

Another satisfaction derived from investing is the ability to support a corporation (that provides jobs) and/or a governmental entity. At another level, satisfaction may be derived from sharing in the success of a corporation. As companies grow, their investors often experience significant gains. Investors enjoy sharing in the success of the company.

Finally, market investments are, by and large, of limited volatility. In contrast to casino gambling, where each card played, roll of the dice, or spin of the wheel can mean one hundred percent loss of an “investment” almost instantly, stocks and bonds typically remain stable over weeks, months and even years. Accordingly, investing in market securities provides unique entertainment and satisfaction that is unlike gambling or wagering.

However, tracking the values of the stock of large corporations can be of limited entertainment value for many reasons. The value of stocks and/or bonds are typically affected by events that do not typically have any entertainment value, such as corporate earnings announcements, consolidations, and the like. Moreover, the research related to informed investing involves tedious review of annual reports, balance sheets and the like.

Accordingly, there is a lack of investment formats that combine some form of underlying entertainment in addition to a limited degree of economic risk. Straight gaming, such as casino gambling, provides some entertainment, but involves a relatively high degree of risk, high volatility, little or no factual analysis, and often predetermined adverse odds.

Accordingly, there is a lack of true investment devices that combine many of the satisfactions of securities investing without the tedium associated with corporate and governmental finance.

### SUMMARY OF THE INVENTION

The present invention creates an entertaining financial market that affords the general public the unique and exciting opportunity to buy and sell performers' and/or celebrities' incomes as if they were stocks or bonds. The trading medium described herein may even leverage the reach and efficiency of the Internet to redefine how the public participates in the success of performers.

The present invention is primarily adaptable to allow trading of income of performers such as professional athletes, actors, musicians and authors. Professional athletes and other performers share the quality of having at least one aspect of their income that is variable. Moreover, professional athletes and other performers share the quality of having large fan bases and having wide notoriety. This combination provides user interest in both the subject matter of the traded security and the element of risk that draws people to securities trading. While the present invention is widely applicable to performers, the exemplary embodiment described herein is directed specifically to sports figures.

In one embodiment, the present invention is a security instrument having a value based on the prospective income of a performer. The value is based at least in part on a contingent portion of the prospective income, the prospective income being service based. Optionally, the value may also be based on a base portion of the prospective income.

In another embodiment, the present invention is a system for trading in a security having a value based on the prospective income of a performer. The system includes a first processor and a plurality of remote processors. The first processor receives and stores a plurality of bids for the purchase of one or more security instruments, each security instrument having a value based on the prospective income of a performer, the value based at least in part on a contingent portion of the prospective income, the prospective income being service based. The plurality of remote processors are further adapted operable to communicate the plurality of bids to the first processor.

The above discussed features and advantages, as well as others, will become more readily apparent by those of ordinary skill in the art by reference to the following detailed description and accompany drawings.

### BRIEF DESCRIPTION OF THE DRAWINGS

FIG. 1 shows a processing apparatus that may be used in connection with the present invention;

FIG. 2 shows an obligation agreement between a performer and a second party in accordance with the present invention;

FIG. 3 shows a diagram of the elements of a system and method for establishing and trading a tradable security according to the present invention;

FIG. 4 shows a flow diagram of steps of a method for establishing and trading a tradable security according to the present invention;

FIG. 5 shows a network system that may be used in accordance with various aspects of the present invention; and

FIG. 6 shows a diagram of the element of a second exemplary system and method for establishing and trading a tradable security according to the present invention.

### DETAILED DESCRIPTION

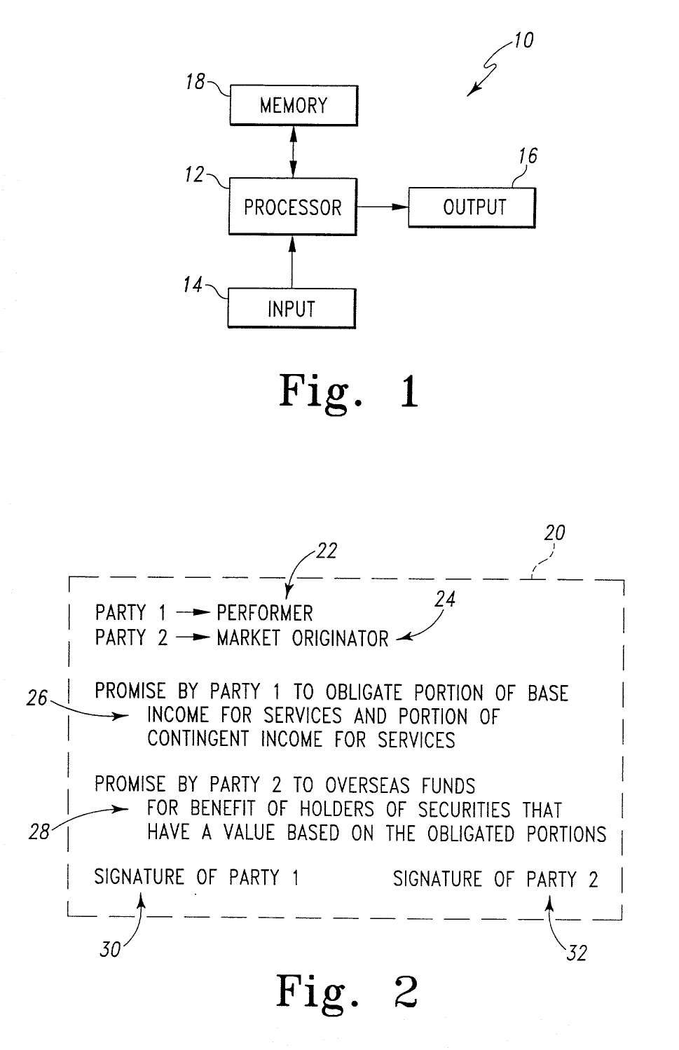

FIG. 1 shows a processing apparatus that may be used in connection with the present invention. The processing apparatus 10 includes a processor 12, an input 14, an output 16, and a memory 18. The processor 12 may suitably be a general purpose microprocessor, a controller or microcontroller, a special mathematical processor, a digital signal processor, combinations of discrete logic devices and/or programmable logic devices, or any combination of the above that are operable to carry out one or more of the steps described herein. For example, the processor 12 may be employed to carry out many of the financial calculations described herein.

The input 14 is a device that provides information to the processor 12. The input 14 may suitably be a user interface input such as a keyboard, a mouse, or other device. The input 14 may also be a communications input such as a modem, network interface, or the like. The output 16 is a device that communicates information generated or processed by the processor 12 to an external device or human being. To this end, the output 16 may suitably be, among other things, a visible display device, an external network connection or modem.

The memory 18 is a one or several devices that provide temporary and/or permanent storage of programming instructions, input data, output data, and interim data employed and/or generated by the processor 12. Accordingly, the memory 18 typically includes many independent memory devices, such as random access memory, read-only memory, disk drive devices, CD-ROM devices, and the like.

The processing apparatus 10 of FIG. 1 may be adapted to perform many of the operations described below. Indeed, several different processing apparatus having the general structure shown in FIG. 1 may be employed to perform different operations described herein.

The various aspects of the present invention generally include, but are not limited, a security instrument that is based on the service-based prospective income of a performer, methods of valuing such a security, methods of underwriting and selling such a security, methods of limiting risk in such a security. Other aspects will become readily apparent.

In general, one aspect of the invention involves using funds actually provided by performer after the performer has earned them. In other words, while a system could be set up that merely wagers on the financial success of a particular performer, without actually being economically linked to the performer, the preferred embodiment of the invention actually links the security value to the prospective income on which it is based.

As a result, the invention preferably involves obtaining an agreement from a performer to create a repayment obligation based on a portion of a prospective income stream of the performer, the portion of the prospective income stream including service-based income. The prospective income stream represents the basis of the investment. After the obligation is completed, the investor receives the realized portion of the obligated prospective income stream.

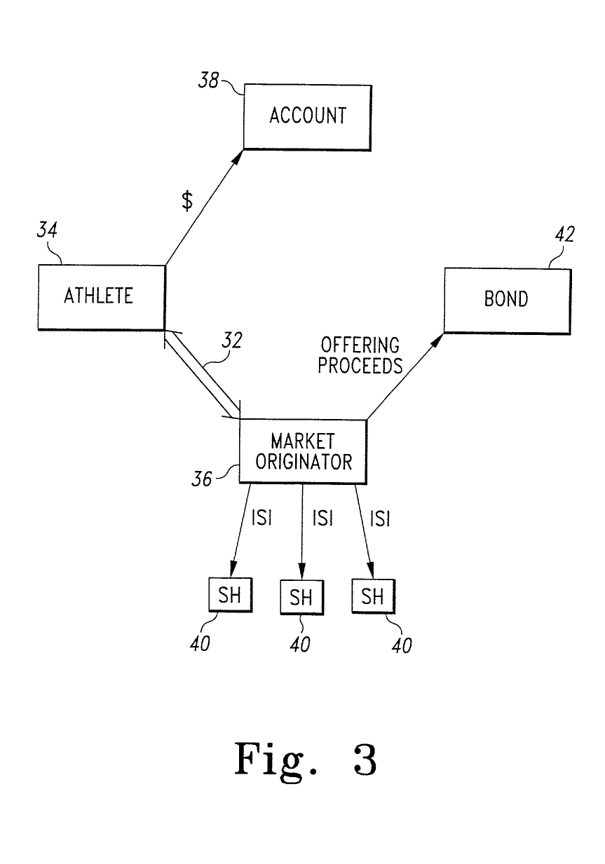

Accordingly, a first element of the system is the agreement to created the repayment obligation. FIG. 2 shows an example of an obligation agreement 20 according to the present invention. The obligation agreement 20 includes a first party identification 22, a second party identification 24, a first promise 26, a second promise 28, and first and second signatures 30 and 32.

The first party identification 22 is an identification of a performer who has at least some prospective service-based income. In particular, service-based income means income derived from the performance of services, as opposed to the sale of goods. For example, contract payments to an athlete for participating in a team sport constitutes service-based income, as does prize money from a tennis or golf tournament. Ticket and/or television revenue from a performance also qualify as service-based income.

The second party identification 24 is an identification of a party that will perform services to oversee an account in which funds are deposited for the benefit of purchasers of security instruments that have a value based on at least a portion of the prospective income of the performer. For example, the second party may be an underwriter.

The first promise 26 is a promise by the first party (i.e. the performer) to obligate a portion of the prospective service-based income for the purposes of forming the basis of the security instruments. The portion of the prospective service-based income may include base income and contingent income, particularly for athletic performers. Base income is income that is effectively guaranteed to the performer for merely participating, whereas contingent income is only guaranteed if the performer achieves a measurable level of performance. For example, professional team sport athletes typically have a base salary to which they are entitled if they participate in the sport. Team sport athletes often have contingent income that depends upon achieving certain measurable performance goals, such as hitting a number of home runs, rushing for a number of yards, making an all-star team. Preferably, the portion of prospective income that makes up the repayment obligation includes contingent income because the uncertainty of such income allows for a more interesting market to analyze and participate in. The inclusion of base income reduces the risk somewhat and increases the amount of funds available to create the security, as base income is often a high percentage of the overall compensation of an athlete.

The second promise 28 is a promise by the second party to oversee funds for the benefit of the holders of securities to be sold. The second promise 28 may, but need not, be a promise to act as a trustee. The second promise 28 may further include a promise to underwrite the securities. The first promise 26 and the second promise 28 may obviously be worded in an infinite number of ways and take various forms, and the precise wording is not critical.

Moreover, the contract 20 typically will include a myriad of other clauses, promises and elements, and may identify other parties that are involved in the contract. At least two examples of such contracts are discussed below.

The first and second party signature lines 30 and 32 provide a location in which the mutual assent of the parties may be memorialized. Such memorialization may be via handwritten signature or electronic signature.

Once the repayment obligation is made, embodiments according to the invention further involve selling a security having a value based on a value of the repayment obligation. Thus, if one hundred dollars of prospective income is obligated, then security instruments may be sold based on the one hundred dollars. The actual dollar value of the security instrument may vary based on a number of factors, but the basis of the security instrument is the obligated portion of prospective income. If all of the income is realized after the obligation ends, then the securities have a monetary redemption value equal to the one hundred dollars. If not all of the income is realized after the obligation ends, then the securities have a monetary redemption value that is less than one hundred dollars.

Because the security instruments will have a redemption value once the obligation ends, the present invention preferably also involves receiving into an account payments towards the repayment obligation. For example, such payments may be made as the prospective income is earned. However, some or all of the repayment obligation may be made in advance and/or from proceeds from the sale of the security offering.

A first embodiment described herein is the performer income trading system and method. This embodiment is described in relation to an athlete, but it will be appreciated that the principles of the invention may readily be adapted for use with a non-athletic performer. The performer income trading system includes various elements, including a risk transfer agreement and an income security instrument.

The risk transfer agreement (“RTA”) is best described as an investment savings and management agreement that contractually binds professional athletes to save an amount of money equal to a specified portion of performance-related income streams. The RTA represents one embodiment of the obligation agreement 20 of FIG. 2.

The income security instrument represents the transformation of the risk transfer agreement into an investment opportunity for both professional athletes and sports fans alike.

Setting up the Market

Setting up the market initially requires contracting with athletes to create RTA contracts. Professional athletes have but few options to insure their careers against possible risk, which commonly resides with pricey disability insurance from firms like Lloyds of London. Additionally, these types of policies fail to insure the inherent risks associated with contracted performance incentives that directly hinge on a player's ability to perform on the field. Research indicates that these performance incentives often exceed 30% of an athlete's contracted earnings annually. Although these incentives are included in the amount of the player's advertised contract, the player may or may not receive these earnings during his career. Hence much of an athlete's Net Present Value lies with potential income streams that he may never see, or is unable to insure from subsequent loss.

The RTA and income security instruments address this shortcoming. Through the RTA and income security instruments, the athlete not only creates a solid investment strategy for the future, he also is able to hedge many of the risks associated with performance-related income streams during the time he plays professional athletics.

Creating value for professional athletes, however, also provides the opportunity to issue these instruments as securities to individuals interested in taking an entertaining investment position in pro-athletes.

The average cost of taking a family of four to a sporting event has recently risen substantially. As a result, professional athletics' most loyal subscriber base—namely the middle class family—has begun to seek out new means to participate in the sports they love to follow.

To this end, sports fans have begun participating in fantasy sports stock exchanges, where athletes are transformed into imaginary “stocks” that fluctuate in accordance with the supply and demand for a particular athlete. Companies like Sandbox Entertainment, the operator of WallStreetSports.com, offer such an exchange. Such activities have enjoyed enormous popularity. Research indicates that fans' subsequent desire for a “piece of the action” will only grow more intense as athletes continue to make, and demand for, greater compensation.

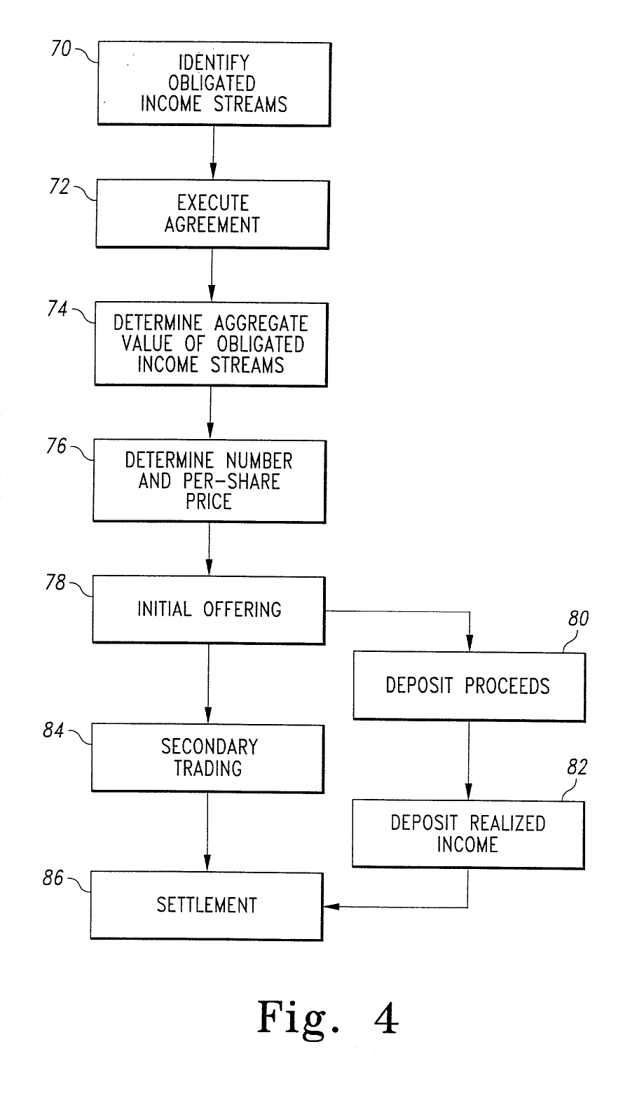

The RTA and income security instruments allow the sports fan to participate in a more meaningful way in the success or failure the athletes that they follow. Further detail regarding these elements are provided below, with reference to FIG. 3. The processes are illustrated through the flow diagram of FIG. 4.

The Risk Transfer Agreement

The RTA 32 is best described as an investment management agreement between a professional athlete 34 and a market originator 36. The market originator 36 is a business entity, along with its agents, partners, and subcontractors, that create tradable asset based on the athlete's prospective income.

The RTA 32 serves to contractually bind the athlete 34 to save a specified portion of performance-related income streams during a finite period in which the athlete 34 participates in professional athletics. This obligation not only creates an investment plan for the athlete 34, it also paves the way for the market originator 36 and the athlete 34 to sell a tradable asset that is based on the pledged income streams in fractionalized form to public investors 40.

The development of an RTA 32 can be divided into 3 steps. Each step is described in detail below.

Negotiating the Source of Contracted Income Streams

The process begins with negotiations between the athlete 34 and the market originator 36 regarding the athlete's investment goals using the RTA 32. Principally, the athlete 34 and the market originator 36 must come to an agreement as to how much and what type of income streams will be obligated or pledged by the RTA 32 (step 70 of FIG. 4). In identifying the income streams pledged to the RTA 32, the athlete merely states that such an investment will occur if and when the negotiated income stream is earned. In the embodiment described herein, the three sources include base salary, individual performance incentives, and team performance incentives. However, in other embodiments, other obligated income streams may be used. For example, a golfer obligated income streams may include tournament prize money.

Thus, the market originator 36 negotiates with the athlete the percentage of base salary he would like to obligate through the RTA 32 during the contracted period. The athlete has the option to pledge a portion, preferably between 5% and 40%, of his gross base salary, but shall never in any year be able to pledge over 99% of his gross income streams. Termed the RTA cap, this limitation is placed upon the athlete to prevent him from becoming disincented to play professional athletics during the term of the RTA period. There are advantages to creating an RTA cap of 49% or lower. Such RTA caps provide the athlete with significant incentive to perform adequately to receive his or her base salary.

Once the proportionate sum of the athlete's base salary is agreed upon, the market originator 36 negotiates with the athlete the percentage of each individual performance incentive he would like to obligate through the RTA 32. Once again, contracted proceeds preferably, but not necessarily, do not exceed 40% of the athlete's gross compensation for attaining the contracted incentives.

Finally, the market originator 36 negotiates the percentage of each team-based performance incentive the athlete 34 wishes to obligate to the RTA 32. The RTA cap also applies to team-based incentives contracted in the RTA 32.

Establishing the RTA

Once the athlete 34 agrees upon the source and type of income streams pledged to the RTA 32, the next step is to outline and solidify the mechanics of the negotiated agreement. Here, two things must be accomplished to proceed to the final step in creating the RTA 32.

In order to ensure the athlete 34 abides by the terms set forth in the RTA 32, the athlete 34 agrees to entrust the market originator 36 or other trustee with his pledged income streams during the contract period. Such agreement constitutes a promise within the RTA 32. This is accomplished by the athlete 34 placing his negotiated, actualized income streams into a trust account 38 that is being actively managed by a trustee on behalf of the athlete 36.

The market originator 36 or other trustee agrees to oversee the trust account 38 for the benefit of the investors. As a result of this oversight, the invested income streams of the RTA 32 will not be able to be directly accessed by the athlete 34 during the RTA contract period. The agreement to place the pledged income streams in trust will act to safeguard the athlete's investment as well as protect the public investor from any unacceptable default. An unacceptable default can include any willing failure to make payments in to the account 38. In this light, should the athlete 34 unacceptably default on the RTA 32, the trustee or market originator 36 retains the ability monetarily penalize the athlete on his failure to execute his negotiated RTA 32.

Though the income streams pledged by the athlete 34 will be placed into an account 38 subject to the control or oversight of the market originator 36 (or trustee), that account 38 may be actively managed by an investment manager selected by the athlete 34 on his or her behalf. The athlete 34 has the option of either using an investment adviser already allied with the market originator 36, or the athlete 34 may use his or her personal existing financial adviser that agrees to manage the RTA monies in the manner described above. This adviser, who may act in concert with the market originator 36, will be authorized to make investment decisions over the RTA income, so long as certain investment criteria are met in accordance with standard financial management practices. Limitations will also be placed on the adviser as to what distributions (if any) can be made to the athlete during the time the athlete owes income streams to the firm.

Executing the RTA

In the final step of the preparation of the RTA 32, the athlete 34, the appointed RTA investment manager (which may or may not be an agent of the market originator 36), and the market originator 36 execute the RTA 32 (step 72 of FIG. 4).

The RTA 32 has the general structure of the agreement of FIG. 2, but includes further elements as described herein. It will be noted that the concepts and principles embodied in those documents and described herein may be implemented in other ways by those of ordinary skill in the art while still retaining the benefits and advantages of the present inventions.

The Trading System

The RTA 32 generates tradable assets having a basis in the potential income of performers, and in the example described herein, athletes. The tradable assets are then the basis for tradable securities. As will be discussed below, the securities may be initially offered at the net present value of the prospective income that is obligated in the RTA 32. The net present value takes into account the likelihood of obtaining the prospective income streams as well as the time value of money. The net present value of the RTA-pledged income streams is referred to generically above as the asset present value.

At least some of the benefits of the present invention may be realized regardless of how the securities are actually traded. However, one example particularly suited to the environment in which the securities will be traded is the online market described herein.

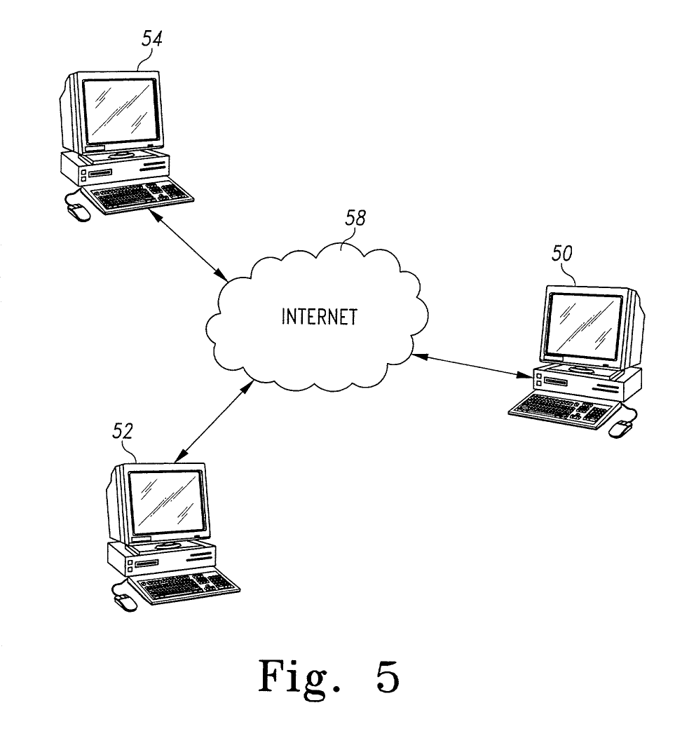

In accordance with the exemplary embodiment described herein, the online market employs the Internet as the primary trading vehicle. FIG. 5 shows an example of the online system. Referring to FIG. 5, a first computer 50 (which includes one or more processing apparatus such as the processing apparatus 10 of FIG. 1) is employed to “host” the online market trading system. Plural other remote computers 52, 54 (also including processing apparatus) may be employed by investors 40 (see FIG. 3), or agents or brokers acting on behalf of investors 40 to trade in the income security instrument described herein. The first computer 50 and the remote computers 52, 54 are operable connected to communicate with each other via a network, which in the exemplary embodiment described herein is the Internet 58.

The Income Security Instrument

The RTA 32 facilitates creation of a security that can be traded on an open market because of the RTA's fundamental pledge by the athlete 34 to provide the market originator 36 (on his behalf) income streams if he attains those earnings on the playing field. Since the RTA 32 constitutes a legal agreement for payment over a negotiated period of time, the athlete's yet-to-be-earned cash flows have the ability to be securitized.

The present invention, among other things, creates a financial instrument that caters to both fun-loving fans, who wish to “get a piece of the action” in professional sports, as well as to other individual investors who wish to invest for capital gain on an innovative, entertaining and efficient financial market. In this vein, the income security instrument (ISI) is designed around a framework that offers compelling financial upside, with limited exposure to significant financial loss for the public investor. In the present embodiment, the ISI is structured as follows:

Athlete Analysis and RTA Valuation

In order to maximize profitability while mitigating risk, the market originator 36 begins the ISI development process with a strategic assessment of an athlete's performance potential. The performance potential analysis is critical to the valuation of an athlete for resale, since the appraisal of his inherent ability to perform on the field will directly affect what the public will pay for the athlete's yet-to-be earned income streams. The market originator 36 performs this assessment by using a proprietary framework that systematically assesses an athlete's potential earnings ability over the life of the RTA 32 (step 74 of FIG. 4). It will be noted that the results of the assessment and valuation may actually form a part of the RTA 32 executed by the athlete 34 and the market originator 36, in which case step 74 would occur prior to step 72.

In particular, one aspect of valuing the RTA is assessment of the athlete. The athlete is evaluated in several distinct areas that are believed to be most important to predicting the future financial outcome of his performance. The assessment takes into account such things as the probability of physical injury, past performance history, team prospects, and other pertinent factors that accurately assess the risk of investment. These areas aim to concentrate in fields that have the greatest impact on the athlete's performance, which directly impacts the athlete's financial earnings potential during the years that he plays professional sports.

Based on the above-described athlete assessment, the market originator 36 determines its confidence weighting for each individual element of the athlete's RTA 32. Because the athlete 34 has a greater probability of attaining some income streams over others, it is preferable to treat each income stream separately to soundly value his performance potential. A probability value will be assigned to each variable element of the athlete's contract, and these values, expressed as percentages, will be used to discount each element of income to arrive at the athlete's predicted actual cash flow value during the contracted time period.

For example, suppose the athlete 34 is a baseball player that obligates through an RTA $400,000 of base income for one year and $200,000 of incentive income including $150,000 for hitting thirty home runs and $50,000 for making the all star team. Based on various assessment factors, the confidence level of earning the base salary is 95%, the confidence level in hitting thirty home runs is 50%, and the confidence level of making the all star team is 60%. The value of the RTA 32 in such a case, not adjusted for the time value of money, is (0.95)(400,000)+(0.50)(150,000)+(0.60)(50,000) or 380,000+75,000+30,000 or 485,000.

Once the confidence weightings are applied to each potential income stream, the time value of money is factored into the RTA valuation. To this end, the market originator 36 in the exemplary embodiment described herein applies a discount rate that reflects the public investor's opportunity costs associated with the decision to purchase the ISI. Such a discount rate closely resembles the discount rate used in pricing government-backed securities of similar maturity. Such rates are preferable because they are relatively stable and usually reflect the present-value of money today when compared to the current trends of risk-free investment opportunities and the rate of monetary inflation. The resultant value represents the initial RTA valuation.

For example, suppose the athlete 34 is a baseball player that obligates through an RTA having a one year contract period $400,000 of base salary and $200,000 of incentive income including $150,000 for hitting thirty home runs and $50,000 for making the all star team. Based on various assessment factors, the confidence level of earning the base salary is 95%, the confidence level in hitting thirty home runs is 50%, and the confidence level of making the all star team is 60%. The value of the RTA 32 in such a case, not adjusted for the time value of money, is (0.95)(400,000)+(0.50)(150,000)+(0.60)(50,000) or 380,000+75,000+30,000 or 485,000. Assume that the time value of money is calculated to be 95% for the one year RTA contract period. In other words, every dollar obligated to be paid to the investors at the final settlement one year from the initial offering is worth ninety-five cents at the initial offering. Factoring in the time value of money, the initial RTA valuation would then be (0.95)(485,000) or approximately 460,750.

Referring again to the general description of the embodiment of FIG. 3, when performing the athlete assessment and confidence weighting, the market originator 36 may suitably use multiple regression analysis to identify the key factors that affect the player's earnings potential. The analysis will be broken up depending on their position, team, sports league, and other demographic information. This data will aid the market originator 36 in determining each player's appropriate earnings potential and thus the value of the ISI. Once the initial RTA valuation is complete, the market originator 36 then completes the transformation of the RTA 32 into the ISI.

It will be appreciated that some or all of the athlete analysis and valuation steps described above may be accomplished by the processing apparatus 10 of FIG. 1.

RTA Fractionalization and Issuance

Once the RTA income streams have been valued at an aggregate level in step 74, the market originator 36 then fractionalizes the income streams into units of issue for sale to the public (step 76 of FIG. 4).

The market originator 36 divides the aggregated, discounted income streams, i.e. the initial RTA valuation, into enough ISI shares that will provide adequate liquidity and affordability to the investors it seeks to serve. Once a suitable initial share price is identified, the number of shares to be offered may be determined. The number of shares is determined by dividing the initial RTA valuation by the identified initial share price. Conversely, if a number of shares is identified first, then the per-share price is determined based on the number of shares and the RTA valuation. Effectively, to obtain the offer price of the ISI shares, the initial RTA valuation is divided into the number of ISI shares to be offered. Either calculation may be carried out by a processing apparatus such as the processing apparatus 10 of FIG. 1 The ISI shares are sold to the general public at a specified price and time (step 78 of FIG. 4), and a portion of the proceeds from the sale will immediately be used to establish a secured instrument 42 (step 80 of FIG. 4), which may include, for example, one or more like-maturity government bonds on behalf of the athlete 34. In doing so, the system of the present invention hedges public investors' 40 investment in ISI shares against any unacceptable defaults the athlete may engage in during the RTA contract period. In one embodiment, the bond(s) 42 is/are purchased with a maturity value equal to 100% of the public investors' initial investment. In other embodiments, this percent backing may be reduced below 100% to allow for higher yield investments and further risk sharing between the athlete 34 and the public investors 40.

In any event, the hedge will ensure that at the end of the RTA contract maturity or time t the original public investor will, at a minimum, receive what he initially paid for his ISI shares (or a fraction thereof in alternative embodiments). Thus, in the preferred embodiment, should the proceeds from the repayments made into the account 38 fail to meet or exceed the initial strike price at maturity, the original investor 40 will always receive his or her money back from the market originator 36 and the athlete 34.

As a result of this stabilizing hedge, the market originator 36 can create an innovative and exciting security that combines strong positive upside potential with limited downside risk to the public investors 40.

The initial offering (step 78 of FIG. 4) may employ a single price auction method and may be carried using a website 50 (see FIG. 5) and a plurality of remote computers 52, 54. Investors may bid on the ISI shares at the initial offering, with the minimum bid set at the determined per share price. Once the auction closes, the actual price may differ from the determined initial price if there is high demand for the ISI.

Settlement

Once the bond(s) 42 is/are purchased and fees are collected for facilitating the ISI issuance, the athlete 32 will receive into the trust account 38 the marginal difference between the value of the offering and the cost of the security account bond(s) 42. The resulting gain can be invested just as the athlete's pledged income streams are invested by his RTA investment adviser. Moreover, in some embodiments, the like maturity, government-backed bond(s) 42 may also be placed in the athlete's account 38, but will remain illiquid until approval by the market originator 36 for investment or liquidation.

Once signed, the athlete 32 will make regular, scheduled payments to the account 38 throughout the RTA contract period based on the percentage of gross income agreed upon in the RTA 32, (step 82 of FIG. 4). Once again, only actualized income streams will be obligated to the account 38, and the athlete 34 bears no responsibility to the account 38 (or the investors 40) for those income streams that were scheduled but not earned in the performance of his or her duties as a professional athlete.

When the contracted period concludes, the account 38 will be liquidated in accordance with the RTA 32 and the principal and interest of the account 38 will be made to the athlete 34 in full during settlement (step 86 of FIG. 4). Should the athlete 34 have another contract pending, the athlete will have the option of entering into another RTA 32. In such a scenario, the account 38 could suitably remain in existence, and a new RTA 32 would be created. Using the same structure for multiple contracts of an athlete can reduce certain transaction costs of the market originator 36.

Upon the conclusion of the contract period, the public investor 40 will receive either his proportional value of the athlete's income streams or the proportional value of the bond(s) 42—whichever is greater. The athlete 34, in accordance with the RTA 32, will receive full ownership of the funds in the account 38, less whatever is owed to the public investors 40.

To determine what the per share payment is, the processing apparatus 10 of FIG. 1 may be employed. For example, the processor 12 may receive through the input 14 the number of ISI shares sold, and may also obtain information identifying the total value of the realized obligated income streams. The processor 12 then determines the per share redemption value, typically by dividing the total value by the number of shares sold. The processor 12 provides the information to an output.

Trading ISI Shares

Secondary trading of ISI shares may occur during the contract period (step 84 of FIG. 4). As discussed above, the Internet 58 may provide a medium for an efficient, stable, and liquid marketplace for its investors 40 to facilitate trading of ISI shares. The first computer 50 may be configured to efficiently and economically issue and/or facilitate the trading of ISI shares via an Internet-based website open to the general public. The website is stored/operated by the computer 50 and thus will also be referenced with the reference numeral 50. Preferably, the website 50 is configured in a manner that reduces the complexity in overcoming challenges posed by governmental regulatory agencies. One may ask at this point just how such a pioneering market can be created in the face of the significant governmental regulation of national securities exchanges. Fortunately that question can be answered when one investigates the government's most recent position regarding the use of alternative trading systems as financial trading media.

The website 50 contains effectively, an alternative market system called a Proprietary Trading System (PTS). A PTS, as defined by the Securities and Exchange Commission (SEC), is any alternative trading system that operates privately for profit, and has the option of classifying itself as either a “national exchange” or “broker-dealer”.

The PTS on the website 50 may suitably be similar to the Arizona Stock Exchange (AZX), created by Steven Wunsch. In 1991, the AZX became the first fully independent exchange to receive a “national exchange” classification exemption from the SEC. This ruling paved the way for other automated trading places to use the AZX precedent for similar exemption status (see SEC Release No. 28899 [Feb. 20, 1991], 56 FR 8377). The AZX provides an extremely useful framework upon which to build a market like the one created by the RTA 32 and the ISI shares. The AZX currently uses a highly efficient, electronically managed Single Price Auction system, where securities listed on the NYSE and NASDAQ are independently traded over the Internet to customers around the world. The website 50 preferably uses the structural framework grounded in AZX's Single Price Auction system to create the electronic exchange for the exclusive trading of asset-backed ISI shares.

Funding of the operations for the market will primarily come from maintaining membership trading accounts on the proprietary trading website 50. Investors 40, who use computers such as remote computers 52 and 54 will be charged a small account management fee, presently set at $5 per month, to trade unlimitedly on the website 50.

Investors 42 will also have the option of subscribing to various information services that provide personalized reports on the athletes they are most interested in trading. The information services provider may suitably charge a fee to investors who wish to have these specialized services provided.

In one embodiment, the market originator 36 that obtains the RTA 32 may also offer the securities and maintain the trading website 50. The market originator 36 may also provide at least some of the investment information services via the website 50 or via another website. Several efficiencies may be obtained by consolidating all of the activities into one market originator company/firm. However, it will be appreciated that most of the advantages of the present invention may be obtained regardless of whether the various service functions are integrated.

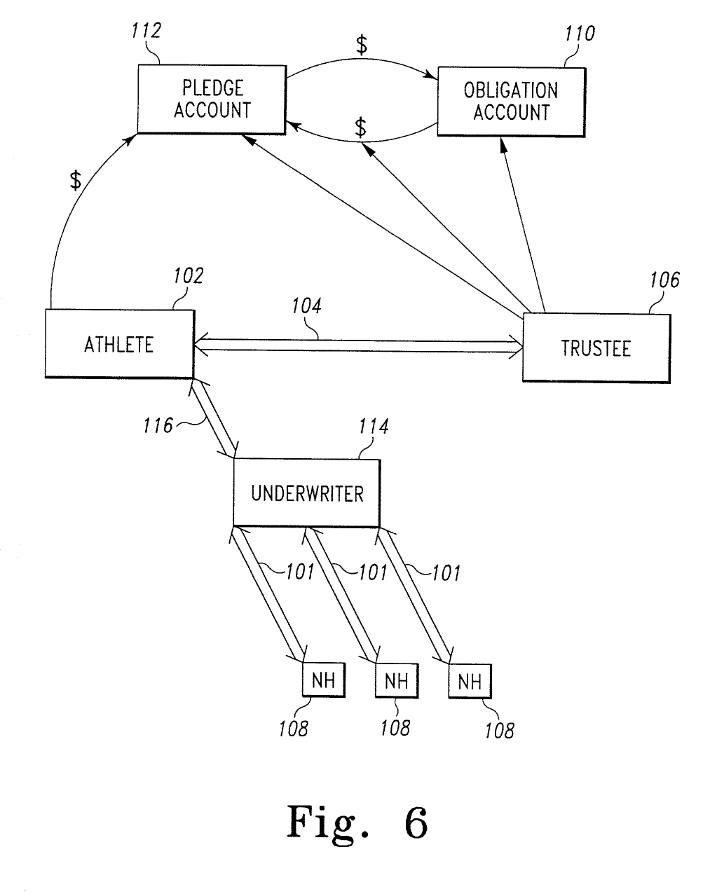

The above described embodiments show various features of the several aspects of the present invention. Another group of embodiments discussed below in connection with FIG. 6 show many of the same features embodied in a different way.

FIG. 6 shows, in general, the various elements of a system and method for trading in performer's incomes according to other embodiments of the various aspects of the invention. The system will be generally described as the performer income note (PIN) system.

This description of the PIN system includes an overview and then describes the PIN system from six functional and operational perspectives. The description concludes with an example of how a particular PIN system offering occurs, from the initial structuring stage through marketing of the offering, settlement of the offering and secondary trading after the offering. Reference is freely made to the drawings attached hereto.

As with the system illustrated in FIG. 3 and discussed above, the PIN system is designed to enable an individual professional athlete to reduce the uncertainty associated with his variable compensation, while allowing investors to earn returns based on that athlete's achievement of both “base” and “incentive” compensation targets that are derived from that athlete's contract with his particular team. While the PIN system is applicable to performers having contingent income streams as well as notoriety, the example described herein will pertain to athletes.

In the embodiment of the PIN system described herein, each issue of a performer income note 101 will be a debt obligation of an athlete 102 that will not exceed $5.0 million in principal amount. The operative terms of each issue will be set forth in an indenture 104 to be entered into at the time of initial issuance between the athlete and a financial institution that will act as trustee 106 for the benefit of the noteholders 108. In general, the indenture 104 defines the scope of the athlete's performance obligations to his noteholders 108, and will be structured to parallel insofar as practicable the requirements of the Trust Indenture Act of 1939.

At the time of initial issuance, the athlete 102 is required to deposit funds sufficient to repay the stated principal amount of the performer income notes into an account 110 and to grant a first priority security interest in favor of the noteholders 108 in the account 110 and the assets it contains. The account 110, referred to herein as the obligation account 110 will be managed by the trustee 106, in its capacity as collateral agent for the noteholders 108. By the terms of the indenture 104, the trustee 106 will be authorized to invest the contents of the obligation account 110 only in U.S. Government-backed obligations over the duration or term of the performer income notes 101. During the time the performer income notes 101 are outstanding, investors 108 do not receive any payment of principal or interest. However, in addition to maintaining the existence of the obligation account 110 over the term of the notes 101, the athlete 102 is required to make periodic payments into a separate account 112, referred herein as pledge account 112, in which the noteholders 108 will also have a first priority security interest, in an amount calculated to fund the athlete's supplemental redemption amounts owed to noteholders 108 at maturity, as described further below. Investments in the pledge account 112 will be managed by a registered investment adviser selected by the athlete 102, subject to compliance with eligibility and transactional requirements and limitations.

Periodically over the term of the notes 101, assets from the pledge account 112 will be transferred to the obligation account 110 so that the obligation account 110 maintains sufficient funds to fulfill the athlete's obligations to noteholders 108 as those obligations are incurred. To this end, the indenture 104 also grants the trustee 106 limited powers of attorney over the obligation account 110 and the pledge account 112 for the purposes of managing the obligation account 110 and for executing transfers between the pledge account 112 and obligation account 110.

At maturity, investors or noteholders 108 will receive repayment of principal from finds that will have been held in the obligation account 110 since the initial issuance. Noteholders 108 will also be entitled to receive from the obligation account 110 and/or the pledge account 112 a supplemental redemption amount at maturity. The supplemental redemption amount is based on an amount equal to a percentage, agreed to by the athlete prior to initial issuance, of the base and incentive compensation which the athlete actually earns under his contract during the period that the notes 101 are outstanding.

The notes 101 are principal-protected interest contingent notes, a type of security that has been offered and sold in various forms for many years. An early form of contingent payment notes were Union Pacific Railroad's Participating Gold Bonds of the early 1900's. These notes paid noteholders contingent interest if Union Pacific paid dividends to its shareholders. Modem contingent payment notes include SalomonSmithBarney SPINs (S&P 500 Index-Linked Notes) and Merrill Lynch's MITTs (Market Index Target-Term Securities). These notes make no periodic interest payments but offer potential returns at maturity depending on the price of certain securities on the date of maturity.

Between issuance and maturity, the notes 101 are expected to trade on a limited basis, with trading prices expected to be based primarily on investors' perception of the likely magnitude of the supplemental redemption amount to be due to noteholders 108 upon maturity. For example, assume that the structure of a particular issue of the notes 101 was based on the agreement of a baseball player to pay noteholders the equivalent of 5% of his base compensation and 15% of the incentive compensation he could earn if he hit 100 homeruns over a three year period. The notes 101 issued by this baseball player would initially trade at a discount to the maximum possible payment at maturity—i.e., the sum of 5% of the athlete's base compensation plus 15% of the amount payable for bitting the requisite number of homeruns over the period—and would likely appreciate in value to the extent that the athlete's performance over the three year term of the notes 101 demonstrated the likelihood that he would achieve both his base and incentive compensation targets. Conversely, the value of the baseball player's notes 101 would decline to the extent that the player experienced a prolonged hitting slump or was otherwise perceived by the marketplace to be less likely to achieve the performance milestones in his contract.

Functional and Operational Perspectives on the Performer Income Product

As discussed further above, the benefit to the athlete 102 in issuing the notes 101 is to earn predictable income and to hedge the risk that the athlete 102 may not reach the performance objectives in his or her professional sports contracts. In exchange for the issuance of the notes 101, the athlete 102 receives the interest earned on the net proceeds of the initial offering, which should exceed the net present value of the pledged portion of the athlete's base salary because the net present value (including risk factors) of incentive or contingent pay is included in the net proceeds.

Thus, from the athlete's perspective, issuing the notes 101 transfers to the noteholders 108 a portion of the risk, as well as a portion of the reward, that is inherent in the uncertainty of whether the athlete 102 is able to earn both base and incentive compensation over a specified period of his professional sports contract.

By buying the notes 101, the noteholders 108 are effectively agreeing to provide the athlete 102 with the interest earned on the net proceeds of the initial offering deposited in the obligation account 110, in exchange for the athlete's agreement to pay investors an amount at maturity based on the athlete's performance under his professional sports contract. Investors assume a portion of the risk that the athlete will not perform as well as expected under his professional sports contract, in exchange for a potentially greater interest payment based on the maximum amounts the athlete could earn under that contract which are accumulated over the term of the notes 101.

Although the total repayment obligation for any given issue of notes 101 will vary depending on the athlete's agreement and the terms of his particular professional sports contract, the repayment obligation may suitably be between 5-10% of an athlete's total compensation, with base salary comprising 70% of this value and incentive pay comprising the remaining 30%. Typically this 70%/30% breakdown is expected to be structured to be equivalent to 5%-10% of an athlete's base salary compensation over the term of the notes 101, and 5%-20% of the athlete's incentive compensation available over the same period.

The exact percentage of base salary and incentive compensation underlying the issuance of performer income notes 101 is expected to depend largely on the total mix of contracted income streams available to an athlete under his professional sports contract. For example, if the athlete 102 has a contract that provides him the ability to earn proportionally greater amounts from incentive income as opposed to base salary, then the athlete 102 might agree to issue the notes 101 with a repayment obligation equal to 5% of his base salary plus 2% of his incentive pay. On the other hand, if the athlete 102 has smaller incentive amounts in his contract, then the athlete 102 might issue the performer income notes 101 for which the repayment obligation would equal 5% of his earned base salary plus 15% of whatever incentive compensation.

Supplemental redemption amounts owed at any particular time while the notes 101 are outstanding are calculated by adding: (a) the stated principal amount of the notes 101; plus (b) the accumulated base salary and incentive income obligations owed to date on the security minus the stated principal amount of the notes 101. In other words, the supplemental redemption amount is calculated by determining the greater of (1) the accumulated base salary and incentive income obligations owed to date or (2) the stated principle amount.

Thus, for example, the athlete 102 may be a baseball player might that possesses a three-year contract providing for an annual base salary of $2,000,000 with an incentive clause in which at the end of the contract he would receive an additional $800,000 if he hits a cumulative total of 100 homeruns over those three years. Assume also that the athlete 101 has obligated to pay the equivalent of 5% of the base salary plus an amount equivalent to 15% of the incentive pay for reaching his 100 homerun incentive. The total possible redemption amount is $420,000.

After determining and applying the confidence weighting for each portion of the obligated income streams, and after applying a suitable discount rate, assume that the present value of the $420,000 potential redemption amount is $315,000.

Assume that the athlete's performer income notes offering consists of 31,500 individual notes 101 offered at $10 each for the total stated principal amount of $315,000. Over time, the redemption amount grows as he remains employed under his professional sports contract and reaches his incentive targets. Any redemption amounts totaling in excess of $315,000 constitute supplemental redemption amounts. Continuing this example, if the athlete 102 plays two and a half seasons, and thus earns $5,000,000 of base salary, and reaches the 100 homeruns mark halfway through his third season when he then becomes permanently injured, is dismissed from his team, and earns no further base salary under this issue of notes 101, each noteholder 108 receives $10.00 per note of principal plus $1.75 per note of supplemental redemption amount, for a total return of 17.5% over two and a half years. This outcome results from the fact that at the time of his injury the athlete 102 had already earned $5,000,000 of base salary and $800,000 of performance contingent income for having hit 100 homeruns while the notes 101 were outstanding. The athlete 102 is obligated to pay 5% of the base salary he earned ($250,000) plus 15% of the incentive pay he earned ($120,000) for reaching his 100 homerun incentive, for a total of $370,000. Because the aggregate stated principal amount of the notes 101 at issuance was $315,000 and the baseball player's total obligation totals $370,000, the difference between these two numbers, $55,000, represents the total supplemental redemption amount due to noteholders 108. When $370,000 is divided evenly between 31,500 notes, each noteholder 108 receives $11.75 per note, consisting of $10.00 of principal and $1.75 of supplemental redemption amounts.

Noteholders 108 are entitled to a supplemental redemption amount only when an athlete's accumulated realized repayment obligation exceeds the total stated principal amount of the issuance of the notes 101. If the athlete 102 is permanently injured and cut from his team (without being entitled to receive any further salary) after a year and a half, noteholders 108 would receive no supplemental redemption amount, even if the baseball player had hit 100 homeruns prior to being injured and dismissed from his team. At the year and a half point, the athlete's realized repayment obligation would have totaled $270,000 for the period, which equals $150,000 of base salary obligation (5% of his base salary), plus $120,000 of incentive obligation (15% of his $800,000 homerun bonus). The noteholders 108 would not receive any supplemental redemption amount (although they would be entitled to a return of the stated principal amount), because $270,000 is less than the aggregate stated principal amount raised at issuance ($315,000). Such is a risk that athlete 102 hedges, and that noteholders 108 assume, through the operation of the PIN system.

Protection of Investors' Principal and Supplemental Redemption Amounts

Two accounts support the athlete's repayment obligations under the PIN system: the obligation account 110 and the pledge account 112. At the closing of an initial offering, the net proceeds of the offering are added to funds from the pledge account 112 (which, as described below, the athlete 102 will have begun funding prior to issuance) and transferred into the obligation account 110 such that the resulting transfer equals the total stated principal amount of the notes 101. The obligation account 110 is structured to be beyond the reach of the athlete 102 and the athlete's creditors by the perfection prior to issuance of the notes 101) of a first priority security interest in the account 110 and the assets it contains for the benefit of the noteholders 108.

Furthermore, during the term of the notes 101, the obligation account 110 is managed by the trustee 106 for the protection of the noteholders 108. By the terms of the indenture 104, the trustee 106 is restricted to investing the funds in U.S. Government-backed obligations until maturity. At maturity, the funds are returned to the noteholders 108.

In addition to the obligation account 110, a second level of protection is created for the noteholders' benefit by the other perfected first priority security interest in the athlete's pledge account 112. According to the terms of the indenture 104, the athlete 102 is required to begin, even prior to issuance, regular contributions into the pledge account 112. The amounts of these contributions will be calculated so that at the maturity of the notes 101, sufficient funds will have been deposited in the pledge account 112 to allow for the repayment of the notes' principal plus any supplemental redemption amounts due to the noteholders 104. As described below, a portion of the funds periodically will be transferred from the pledge account 112 to the obligation account 110. Thus the pledge account 112 offers additional protection over and above the protection created by the existence of the obligation account 110. The indenture 104 grants the trustee 106 limited powers of attorney to transfer funds from the pledge account 112 to the obligation account 110 whenever necessary.

Continuing the example of the baseball player described above, during the term of the notes, the indenture 104 will require the athlete 102 to place approximately 6% of his biweekly salary into the pledge account 112. This amount represents a pro rata fraction of the total amount the baseball player would be required to pay noteholders 108 if he reaches all of the performance objectives in his professional sports contract. Here, his biweekly contributions to the pledge account 112 are taken as direct debits from his paycheck, by pre-arrangement with his team and his bank, in the amount of $5,385. This amount is equivalent to 5% of his ongoing base salary plus a pro rata fraction of the total incentive pay he would have to share with noteholders 108 if he were successful in hitting 100 homeruns. The amount of $5,385, equals 6.2% of the athlete's bi-weekly gross pay of $87,179. The $5,385 maybe adjusted downward if the athlete 102 fails to reach certain incentives in his contract. For example, if the athlete 102 has an opportunity to earn an incentive each time he hits 40 homeruns in a season, and a season passes without him having reached that target, the trustee 106 may permit the athlete's bi-weekly contributions to be reduced to account for the fact that the athlete 101 will never earn the homerun incentives for that season.

Furthermore, through a reconciliation process that occurs every 90 days, the trustee 106 may direct finds to be transferred from the pledge account 112 into the obligation account 110 so that the obligation account 110 contains sufficient funds to pay all amounts that would be due to noteholders if maturity of the notes were to be accelerated for any reason. To this end, the indenture 104 gives the Trustee 106 limited power of attorney over the pledge account 112 for the purpose of causing transfers between the two accounts whenever necessary. When acting in this capacity, the trustee 106 is acting as the “Calculation Agent”, discussed further below. The obligation account 110 therefore will periodically be funded to contain not only funds sufficient to repay principal, but also funds sufficient to pay all supplemental redemption amounts that have been incurred during the term of the notes 101.

In a further effort to provide satisfactory repayment, the athlete is required by the indenture 104 to maintain the pledge account 112 at a level that, when combined with his obligation account 110, meets specified asset and supplemental redemption amount coverage ratios. Typically, the supplemental redemption amount coverage ratio will be in excess of 2:1 or 3:1 of the maximum supplemental redemption amount due at the time of calculation. If the pledge account 112 sustains losses, the athlete is required by the indenture 104 to add additional funds to the pledge account 112 to maintain the specified coverage ratios.

Protection Following Default

If any event occurs that prevents the athlete 102 from performing (or remaining employed) as a professional athlete, or if the athlete violates the indenture 104, the athlete 102 is deemed to have defaulted on his notes 101. Such events result in an acceleration of repayment obligations. If the default occurs notwithstanding the athlete's good faith efforts to fulfill his repayment obligation (e.g. death, injury resulting in being dismissed from his team, being cut from his team for competitive reasons and being unable to obtain employment with another team within sixty days of being cut from his team), then the athlete 102 is obligated to pay the amount owed to noteholders as of the date the default is declared and the acceleration of payment was required.

If there are “bad faith” acts by the athlete 102 (e.g. termination from his team due to drug abuse, refusal to play, termination for other misconduct, voluntary retirement, or otherwise violating the terms of the Indenture intentionally or unintentionally), then the athlete 102 is required to pay default interest in addition to the normal maturity amounts, to further compensate investors for their lost opportunity. Because the athlete will have been obligated to make bi-weekly contributions to the pledge account 112, no further payments would be required from the athlete 102 in the case of a “bad faith” default. Instead, the trustee 106 would transfer any required funds from the pledge account 112 to the obligation account 110 under the terms of the indenture 104.

Upon any “bad faith” default, the default interest paid to noteholders 108 is calculated using the Applicable Federal Rate (AFR) for medium-term government obligations. The default interest amount paid to investors is in addition to repayment of principal and payment of any supplemental redemption amount already due as a result of the athlete's performance.

In summary, in the case of a “bad faith” default by the athlete 102, the noteholders 108 receive: (1) repayment of principal; (2) any supplemental redemption amount that would otherwise be due; and (3) the default interest for the period the notes 101 were outstanding.

How Performer Income Notes Will Be Offered

A performer income notes offering is made by an offering party, which typically is a broker/dealer but may also be an issuer. To effect distributions of the notes 101, the offering party uses a primary, single price call auction system similar to the electronic single price call auction platforms used today by, among others, the United States Treasury. To purchase securities a performer income notes offering, interested investors must either open a cash brokerage account with the offering party or with a retail brokerage firm that has arranged with the offering party to have electronic access to the offering party's auction. During the auction process, investors submit bids, either electronically via the website 50 (see FIG. 5) or on a system wherein the auction resides, or through their retail brokers (who in turn may use a networked computer system). Once a sufficient number of bids are collected to close the offering, successful bidders' cash accounts are debited to pay for their allotment, and are credited with their allotted beneficial interest of notes 101. The successful bidders become the noteholders 108.

How Performer Income Notes Will Trade in the Secondary Market

The notes 101 may fluctuate in value as interested investors evaluate the ongoing ability of the athlete 102 to reach future performance targets defined in the indenture 104. A proprietary electronic trading system, for example, the system illustrated in FIG. 5 allows investors at computers 52, 54 to buy and sell the notes 101 periodically, for example, once every 90 days.

This alternative trading system will be designed as a multilateral, single price call auction system similar to that used to auction the notes 101 to the public in the initial offering. Once every 90 days, investors will be able to participate in a secondary-market auction. Investors and/or their retail brokerage firm place bids or offers on the website 50 using remote computers such as computers 52 or 54. At the end of each specified trading day the auction closes, the single trading price emerges, and trades are settled.

An Illustrative Example

Provided below is an exemplary process according to the PIN system, described in connection with FIG. 6.

Due Diligence and the Trial Process

The athlete 102 meets with the underwriter 114 to consider making an offering of personal income notes 101. If the underwriter 114 agrees to go forward, the underwriter conducts preliminary due diligence to see whether the athlete 102 meets the underwriter's requirements. Preliminary due diligence would include determining that the athlete 102 is in good standing with his team and his professional sports league.

In the preferred embodiment described herein, it would also include determining that the athlete 102 has an investment adviser who meets certain predetermined criteria. For example, such predetermined criteria may include that the adviser: is registered under the Investment Advisers Act of 1940; is associated with or employed by a nationally recognized financial services firm; possesses an active NASD U-4 file that shows no adverse remarks for the last five years; and has been a registered investment adviser for at least three years.

After completion of preliminary due diligence, the underwriter 114 reviews the compensation schedule under the athlete's professional sports contract to determine whether his projected future income under his contract is sufficient to support a personal income notes offering. It will be appreciated that when a party is identified herein, such as “underwriter” or “offering party”, those parties include persons and organizations that carry out the stated function, along with their agents, employees and other parties under their direction.

The underwriter 114 and the athlete 102 then negotiate the terms and conditions of the indenture 104 as well as the pledge account 112 and obligation account 110, although the actual sizing and pricing of the offering will occur closer to the date of issuance. Also as part of the process, the player's investment adviser agrees to follow certain investment criteria for directing the investment of the assets in the pledge account 112; the adviser can recommend suitable investments for the athlete 102 to authorize, provided such investments comply with the asset allocation restrictions specified in the indenture.

As part of the preferred underwriter due diligence process, the athlete 102 must pass a “trial period” wherein he voluntarily complies with the terms of the indenture 104 prior to its execution. This trial period, which occurs prior to filing the Regulation A filing, begins when the athlete 102 authorizes his team to make direct debit transfers from his paycheck to the pledge account 112. During such time, the underwriter monitors the athlete's compliance with the general terms of the indenture 104, and monitors the athlete's direct deposit activities to confirm that the pledge account 112 deduction and transfer processes are functioning properly. The trial period may suitably be six weeks.

After the trial period ends, assets that have been deposited in the pledge account 112 are pledged as a security interest in favor of noteholders 108 prior to the issuance. Furthermore, the amount deposited in the pledge account 112 during the trial period equals or exceeds the maximum amount of underwriting commission, plus an amount equal to 30 days' worth of default interest. This allows the athlete 102 to have accumulated an amount in the pledge account 112, prior to making any Regulation A filing, sufficient to meet the Indenture obligations to (1) pay the underwriting fees at issuance, and (2) have deposited enough funds into the obligation account 110 to repay the stated principal amount of the notes at the time of issuance.

Structure and Valuation

The athlete 102 and the underwriter then negotiate the expected offering size of the notes 101. Based on his employment contract to play professional sports for a predetermined number of years, the athlete 102 and the underwriter 114 agree that the underwriter 114 will work towards the goal of underwriting the notes 101 to be issued by the athlete 102.

Under the terms of his professional sports contract, the athlete 102 is eligible to receive a maximum cumulative compensation over the length of the contract if he: (1) remains gainfully employed as a professional athlete; and (2) earns all of the incentive pay available to him based on the incentive targets in his contract. The athlete 102, in light of these compensation parameters, agrees to pay, to the extent earned, a predetermined percentage of his total base salary plus a percentage of his total incentive pay to holders of his performer income notes. This amount is referred to as the obligated income stream.

The underwriter and athlete 102 negotiate an aggregate offering value which reflects a discount that takes into account the time value of money as well as the possibility that the athlete 102 may not reach all of his performance objectives. Pursuant to this negotiation process, the athlete 102 agrees to an aggregate offering amount in return for agreeing to pay the stated percentages of base and incentive pay. The risk adjusted, presently valued repayment obligation is divided into lower cost notes, for example, $10 notes, to determine the number of performer income notes to be distributed in the offering. As with the other embodiments describe above, the processing apparatus 10 may be used to determine the number of shares to be offered based on the initial share price and the total value of the offering.

The Regulation A Filing

During the trial period described above, the athlete 102, the underwriter 114, and their respective legal counsel begin to prepare the Regulation A filing. A disclosure is prepared that includes information concerning the terms of the athlete's professional sports contract and the indenture 104 as well as the athlete's physical condition, including information from his most recent medical exam, his medical history, physical and mental fitness tests, a description of his past injuries, details concerning his historical on-field performance statistics, and relevant financial information. The Regulation A filing also discloses the performance benchmarks by which the athlete 102 can earn income from his professional sports contract.

The Regulation A filing will not be made until the athlete 102 has taken the steps necessary to grant at issuance valid perfected security interests in favor of investors in both the pledge account 112 and obligation account 110.

Prior to the offering becoming qualified, the underwriter and the athlete 102 negotiate and execute an underwriting agreement 116 between the athlete 102 and the underwriter, under which the underwriter 114 agrees to sell the notes 101 to noteholders 108 via a primary auction market system.

The PIN Offering—The Primary Auction System

The Primary Auction Process

The stated principal amount, is preferably, but need not be, equal to the aggregate value of the initial offering determined by the athlete 102 and the underwriter 114 as described above. In one embodiment, the athlete 102 and the underwriter 114 agree that the offering will be conducted on an “all or nothing” basis (i.e. enough bids must be collected in the allotted time frame to sell 100% of the offering at the minimum bid price accepted).

Furthermore, the athlete 102 sets a minimum bid price of the per-note stated principal amount for investors to begin bidding on the securities being offered. Investors alone or through their brokers begin the auction process by submitting bids via the auction website 50 (see FIG. 5). Bids on the notes 101 are accepted for a variable amount of time, depending on demand. It is assumed that the athlete 102 in this example authorizes bids to be accepted for 15 days or until enough bids are collected to successfully complete the terms of the underwriting agreement 116, whichever comes first.

In this example, the bids are aggregated into approximate bid pools. For example, consider an initial offering of 78,750 personal income notes 101 offered at a minimum bid price of $10.00. After the bidding ends, assume that the bids may be broken down into the following aggregate pools:

(i) Bid Pool A contains bids for 15,000 notes at $10.00 per note.

(ii) Bid Pool B contains bids for 25,000 notes at $10.05 per note.

(iii) Bid Pool C contains bids for 58,000 notes at $10.07 per note.

(iv) Bid Pool D contains bids for 2,000 notes at $10.10 per note.

Since 100,000 total bids were received for 78,750 notes, the electronic auction system applies the Vickrey “uniform second price” method of auction resolution to determine the applicable note distributions and a clearing price. Under this method, the execution price is set at the highest price that sells all 78,750 of the notes—in this case $10.05. Because there are 85,000 qualifying bids (from Bid Pools, D, C, and B) for 78,750 notes, each winning bidder is allocated 92.6% of the amount of the notes 101 he/she bid on (i.e. each receives a pro-rata share of the offering that satisfies all qualified bids). Each successful bidder pays $10.05 per note 101, including those who had been willing to pay $10.07 or $10.10 per note 101 as described above. After the auction, the process of clearing and settlement commences. It is noted that even if a networked market is not employed, the auction resolution using the Vickrey method may be accomplished using a processing apparatus such as the processing apparatus 10 of FIG. 1.

Trade Execution and Obligation Account 110 Establishment

Once the offering is completed, the notes are recorded in book-entry form, and a broker executes the clearing and settlement of the offering by crediting notes to the winning bidders and debiting their accounts for the amount needed to purchase their notes 101. The broker is an independently appointed entity, registered as a broker-dealer under the Exchange Act who will carry as its own, customer brokerage accounts. The broker provides a variety of services that include the clearing and settling of PIN system transactions as well as performing the necessary account management activities to maintain and carry customer accounts.

The trustee 106 transfers an amount equal to the underwriting commission from the pledge account 112 to the obligation account 110 and the underwriter 114 transfers an amount equal to the total stated principal amount collected at the offering, net of underwriting commission, into the obligation account 110. The contents of the obligation account 110 now equal 100% of investors' stated principal.

Once settlement is completed, the underwriter 114 schedules and announces the designated secondary market trading days for the notes 101.

Post-Issuance Activities

The athlete's performance on the field of play determines what supplemental redemption amounts noteholders 108 will receive in addition to the stated principal at maturity. To provide security for the repayment obligation, and as required by the indenture 104, the athlete 102 makes scheduled payments to the pledge account 112 by direct deposit. Over three years, Ballplayer's team makes automatic payroll deductions of $14,230 per bi-weekly paycheck to fund the pledge account 112. The $14,230 represents approximately 6% of the athlete's gross bi-weekly paycheck of $237,180. As these amounts are deposited into the pledge account 112, the athlete's investment adviser invests them in marketable securities in compliance with the indenture 104.

While the athlete 102 may direct trading activity in the pledge account 112 with the advice of his investment adviser, the athlete 102 carries an ongoing obligation to maintain the pledge account 112 at a level that, when combined with his obligation account 110, meets the stated principal and supplemental redemption amount coverage ratios in accordance with the indenture 104. The athlete's failure to maintain these predefined ratios constitute a “bad faith” default unless the athlete 102 makes additional deposits to the pledge account 112 to maintain the specified coverage ratios defined in the indenture 104.

The obligation account 110 is administered by the trustee 106. Accordingly, the trustee 106 is preferably a financial institution otherwise eligible to serve as an indenture trustee under the Trust Indenture Act of 1939. The trustee 106 is limited to investing the contents of the obligation account 110 in U.S. Government-backed obligations. The trustee 106 also acts as Calculation Agent, and is responsible for monitoring the sufficiency of account balances in the pledge account 112 and obligation account 110. Every 90 days, the Calculation Agent calculates whether there are enough assets in the obligation account 110 to repay the stated principal and any supplemental redemption amounts that would be due to noteholders 108 if the notes 101 were accelerated and redeemed on that day. If the obligation account 110 does not contain sufficient funds to satisfy such obligations, the trustee 106 transfers funds from the pledge account 112 to the obligation account 110 to cover the shortfall.

To the extent that the Calculation Agent (trustee 106) determines that the obligation account 110 is overfunded, the trustee 106 transfers funds from the obligation account 110 to the pledge account 112 in accordance with the indenture 104. The obligation account 110 is overfunded when it has more money than is required to cover repayment of principal and any accumulated supplemental redemption amounts. The obligation account 110 would most likely reach an overfunded situation when returns are earned on the obligation account 110 contents, which is invested in U.S. Government-backed obligations. As a practical matter this allows any excess funds from the obligation account 110 to be re-invested in issues other than U.S. Government-backed obligations.

The Secondary Trading Market

The alternative market establishes a trading day once per quarter for interested buyers and sellers to transact the notes 101. The secondary market for the notes 101 is available to the public only once every interval of n days (in a preferred mode, n=90) to address potential issues of selective disclosure. The athlete 101, immediately prior to each trading day, is required to publish a periodic disclosure statement disclosing all facts material to trading the notes 101, including injuries, coaching changes, or increased competition for a starting position since the last report. Absent significant time gaps between trading days, the athlete 101 would be at continual risk of selectively disclosing material non-public information through his day-to-day life interactions with his friends, family, and teammates. Limiting trading days reduces this risk and moderates the number of occasions during which the athlete 101 must refrain from sharing non-public material information about his ability to (a) remain employed and (b) reach the incentive targets in his playing contract.

Investors buying and selling notes 101 on the secondary auction market system will also be required to agree in their brokerage account agreements to additional representations about their status and restriction on transfer. Under these representations, noteholders 108 preferably cannot be institutional investors. Only retail customers (and their brokerage firms) may trade notes 108. Likewise, noteholders 108 are preferably prohibited from holding notes 101 excess of specified ownership thresholds (e.g. no investor may own more than 2% of the outstanding notes 101 issued by any one athlete 102), as well as from having more than one brokerage account to transact notes 101. Noteholders 108 are also prohibited from directly influencing the value of the athlete's notes 101 (e.g. they may not be held by his coaches, teammates, or opponents). Other limitations may prohibit trading notes 101 on margin, trading notes 101 outside the designated secondary trading system, and effecting short sales of the notes 101.

Maturity of the Notes

At maturity, the trustee 106, acting as Calculation Agent, determines the precise settlement amount owed to investors. Upon determination of this amount, the accounts 110 and 112 are reconciled such that the proceeds in the obligation account 110 are sufficient to repay principal plus any supplemental redemption amounts owed to noteholders 108 at maturity.

Once the obligation account 110 contains the necessary proceeds to effect final settlement, the trustee 106 liquidates the obligation account 110, and transfers the obligation account 110 proceeds to the underwriter 116 (or its carrying broker) for final settlement. The underwriter's carrying broker credits the noteholders 108 with cash and debits the notes 101. The performer income notes 101 are retired, the trustee 106 releases the security interest on the pledge account 112, and relinquishes its oversight of the pledge account 112.

It will be appreciated that the above describe embodiments are merely illustrative, and that those of ordinary skill in the art may readily devise their own implementations that incorporate the principles of the present invention and fall within the spirit and scope thereof.

We claim:

1. A security instrument having a value based on the prospective income of a performer, the value based at least in part on a contingent portion of the prospective income, the prospective income being service based.

2. The security instrument of claim 1 wherein the prospective income is derived from income obtained through participation in professional sports.

3. The security instrument of claim 1 wherein at least some of the contingent portion of the prospective income is based on the performer's performance in a professional sport.

4. The security instrument of claim 2 wherein:
the performer is a participant in professional team sports; and
at least some of the contingent portion of the prospective income is team performance based.

5. The security instrument of claim 1 further comprising an initial value, wherein the initial value is based in part by past performance of the performer.

6. The security instrument of claim 5 wherein the value is further based at least in part on a base portion of the prospective income.

7. The security instrument of claim 1 further comprising an initial value, the initial value based upon:
a value of performance incentives available to the performer; and
a likelihood of the performer attaining the performance incentives.

8. A method comprising:
underwriting a security instrument having a value based on the prospective income of a performer, the value based at least in part on a contingent portion of the prospective income, the prospective income being service based; and
offering the security for sale.

9. The method of claim 8 wherein offering the security for sale further comprises employing a first computer for receiving bids from a plurality of remote computer, the first computer connected to the remote computers via a network.

10. The method of claim 8 wherein offering the security for sale further comprises connecting the first computer to the remote computers via the Internet.

11. The method of claim 8 wherein the prospective income is derived from income obtained through participation in professional sports.

12. The method of claim 8 wherein at least some of the contingent portion of the prospective income is based on the performer's performance in a professional sport.

13. The method of claim 12 wherein:
the performer is a participant in professional team sports; and
at least some of the contingent portion of the prospective income is team performance based.

14. The method of claim 8 further comprising an initial value, wherein the initial value is based in part by past performance of the performer.

15. The method of claim 8 wherein the value is further based at least in part on a base portion of the prospective income.

16. The method of claim 8 further comprising an initial value, the initial value based upon:
a value of performance incentives available to the performer; and
a likelihood of the performer attaining the performance incentives.

17. A system comprising:
a first processor for receiving and storing a plurality of bids for the purchase of one or more security instruments, each security instrument having a value based on the prospective income of a performer, the value based at least in part on a contingent portion of the prospective income, the prospective income being service based;
a plurality of remote processors operable to communicate the plurality of bids to the first processor.

18. The system of claim 17 wherein the prospective income is derived from income obtained through participation in professional sports.

19. The system of claim 17 wherein at least some of the contingent portion of the prospective income is based on the performer's performance in a professional sport.

20. The system of claim 19 wherein:
the performer is a participant in professional team sports; and
at least some of the contingent portion of the prospective income is team performance based.

21. The system of claim 17 wherein each security instrument further comprises an initial value, wherein the initial value is based in part by past performance of the performer.

22. The system of claim 17 wherein the value is further based at least in part on a base portion of the prospective income.

23. The system of claim 17 wherein each security instrument further comprises an initial value, the initial value based upon:
a value of performance incentives available to the performer; and
a likelihood of the performer attaining the performance incentives.
